(19) United States
(12) Patent Application Publication
(10) Pub. No.: US 2005/0147153 A1
(43) Pub. Date: Jul. 7, 2005

(54) Enclosure integrated temperature detector probe system

(75) Inventor: Rick Lawson, Houston, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: FEDD Systems Inc.

(21) Appl. No.: 11/005,728

(22) Filed: Dec. 7, 2004

Related U.S. Application Data
(60) Provisional application No. 60/527,738, filed on Dec. 8, 2003.

(51) Int. Cl. G01K 7/00

(52) U.S. Cl. 374/179

(57) ABSTRACT

An enclosure integrated detector probe system is provided for manufacturing processes. The system, according to an embodiment, may provide: at least one section of enclosure material having a flow path, the section having a node extending from one wall of the section into a flow path, at least one exhaustible power source, at least one transmitter, and at least one detector located in the node and in electrical communication with the transmitter powered by the exhaustible power source.

### RELATED APPLICATIONS

This application claims priority to U.S. Provisional Application No. 60/527,738, filed on Dec. 8, 2003 and entitled “Enclosure Integrated Temperature Detector Probe System”.

### TECHNICAL FIELD

The invention is directed, according to an embodiment, to process parameter monitoring systems, e.g., temperature detection systems.

### BACKGROUND

In a manufacturing process, temperatures of various components may be important to ensure the success and profitability of the process. Consequently, many different techniques have been proposed and utilized to monitor process temperatures in manufacturing facilities. In many situations, the process being monitored is a closed process, e.g., many pharmaceutical processes. The monitoring of components used in closed processes can be problematic due to the need to ensure the lack of exposure of the process to undesirable outside factors and contaminants. In addition, the maintenance of such temperature detection systems in closed processes can also be problematic due to the need to maintain the closed entegrity of a process. In such systems, to perform maintenance on the temperature detection systems, e.g., the temperature detector, the process has to be shut down to allow entry into the closed process to check, replace, and/or calibrate a measurement device, e.g., a temperature probe. Of course, this down time is not only inconvenient but costs money. Moreover, once the closed process is opened, there is an increased risk of contamination.

### SUMMARY

There is a need for an improved method/system to monitor process parameters of manufacturing processes. Moreover, there is a need for an improved method/system to monitor process parameters in a closed process wherein the entegrity of the closed process is not compromised for routine maintenance and/or repair.

An enclosure integrated temperature detector probe system for use in a manufacturing process is provided. The system, according to one embodiment, may include at least one section of an enclosure material having a flow path for a given substance used in a manufacturing process. The system, according to an embodiment, may include a section having an integrated portion, e.g., a node, extending from one wall of the section into said flow path. The node, according to an embodiment, has walls of substantially the same thickness as the wall of the section of the enclosure surrounding the flow path. And according to an embodiment, the system includes at least one detector, e.g., a temperature detector located in the node to detect a temperature of a substance in the flow path during the manufacturing process.

### BRIEF DESCRIPTION OF THE DRAWINGS

FIG. 1 shows a top view of an embodiment of the present inventive temperature probe device/adapter (temperature probe not shown);

FIG. 2 shows a front view of an embodiment of the present inventive temperature probe device/adapter (temperature probe not shown); and

FIG. 3 shows a side view of an embodiment of the present inventive temperature probe/adapter (temperature probe not shown).

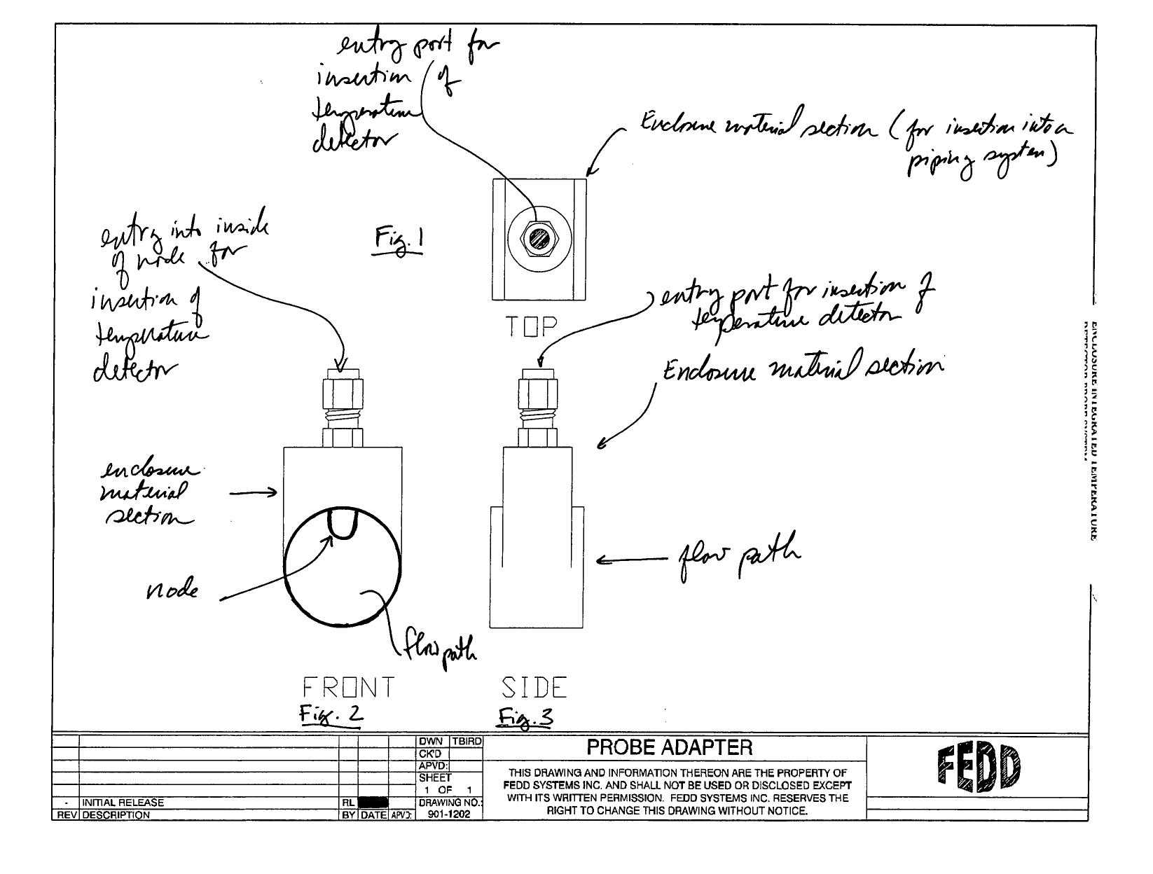

### DETAILED DESCRIPTION

An enclosure integrated temperature detector probe system is provided for a manufacturing process. The system may provide at least one section of an enclosure material, e.g., of pipe material (however, other enclosures and materials may be used as known in the art), having a flow path therein to transport a given substance used during a manufacturing process. The at least one section may have an integrated portion, e.g., a node, which is an integral part of the enclosure section, e.g., a small pipe section for insertion into the piping system of a manufacturing process. The portion or, e.g., the node of the section of enclosure material may extend into the flow path of a given substance used and transported via an enclosure, like piping, during the manufacturing process. The portion or node wall thickness may be the same as the wall thickness of the enclosure material section and of the enclosure material, e.g. a pipe, of the manufacturing process. The node may be provided with a temperature detector as is known in the art to detect the temperature of a given substance during the manufacturing process.

The temperature detector of the system reports the temperature of a given substance during the manufacturing process via hard-wire or telemetry. The detector may be in electrical communication with a battery powered radio frequency transmitter as is known in the art, e.g., a known spread spectrum transmitter to transmit signals relative to the temperature detected. Thus, the detector and the transmitter are powered by the same battery. Any transmitter may be utilized depending upon the application, including but not limited to, gigahertz and megahertz transmitters, and particularly 900 megahertz spread spectrum radio frequency transmitters. The transmitters may transmit an identification code in addition to the temperature to identify the location of the temperature reading. The transmitters may report on a given predetermined time basis automatically, require polling, or transmit when the temperature is outside a given range or close to being outside of a given desired range. In addition, some temperature detectors of a system may report via hard-wire while other temperature detectors may report via telemetry.

The system may also include detectors that detect vibration, pressure, level, and viscosity etc. The system may also include a receiving location (most often a central control room for a given process or facility, but sometimes to a remote location also) for receipt of signals from the temperature detectors, and other detectors if applicable, for reporting the temperature (or other parameter) of a manufacturing process and/or substance. The system may include an alarm such that if a parameter, e.g., a temperature of a given substance is outside of a given range, an alarm is initiated or the process is automatically terminated for a time period until the given parameter is back within desired or designed specifications.

The section of enclosure material may be manufactured from a single piece of material, for example, a block of material, which is machined to form the integrated node. The section of enclosure material may also be manufactured using a casting process designed to form the enclosure section piece with the node.

The temperature detector may be any type of temperature detector as known in the art including thermocouples.

The section of enclosure material may be incorporated into an existing section of enclosure, e.g. a pipe, via welding or clamp connections as known in the art, e.g., tri-clamp connectors as known in the art.

The present invention is particularly applicable to the food and pharmaceutical processing/manufacturing industries (but however is applicable to all industries) where a non-integrated intrusion, for example, a threaded intrusion, into the piping systems would provide disadvantages, including possible contamination, unwanted substance build-up inside the piping, and difficulties maintaining or calibrating the detector. The present invention provides a sterile , safe, easily maintainable system for monitoring temperatures and other parameters in a manufacturing process. For example, the temperature detectors may be replaced, calibrated or checked without intrusion into the piping system and without discontinuing the process, e.g., on the fly. And the utilization of transmitters to transmit the data provides a quick and easy way to upgrade an existing system, e.g., no wires have to be run or connected throughout the plant to report the data to a control room etc.

1. An enclosure integrated temperature detector probe system for a manufacturing process, said system comprising:
at least one section of enclosure material having a flow path for a given substance used in the manufacturing process, said section having an integrated node extending from one wall of the section into said flow path, said node having walls of at least substantially the same thickness as the wall of the section of the enclosure surrounding the flow path;
at least one exhaustible power source comprising a battery;
at least one battery-powered transmitter; and
at least one temperature detector located in the node to detect temperature of a substance in the flow path during the manufacturing process, said detector in electrical communication with the battery-powered transmitter, wherein said transmitter transmits signals relative to a temperature detected by the detector.

2. The system according to claim 1, wherein the battery powered transmitter comprises a megahertz or gigahertz spread spectrum transmitter.

3. The system according to claim 1, wherein the walls of the node and the enclosure have substantially the same thickness.

4. The system according to claim 1, wherein the detector is a thermocouple.

5. The system according to claim 1, wherein the section of the enclosure material is connected to further enclosure material via a clamp connection.

6. The system according to claim 5, wherein the clamp connection is a tri-clamp connection.

7. The system of claim 1, wherein the section of the enclosure material is connected to further enclosure material via a welding connection.

8. The system of claim 1, wherein the section of enclosure material and the node are comprised of a single unitary piece of material.

9. The system of claim 8, wherein the piece is a machined piece.

10. The system of claim 8, wherein the piece is a cast piece.

11. The system of claim 1, wherein the node is hollow.

12. The system of claim 1, wherein the node is not hollow.

13. The system of claim 2, wherein the transmitter is a 900 megahertz spread spectrum transmitter.
